(19) United States
(12) Patent Application Publication
(10) Pub. No.: US 2025/0232280 A1
(43) Pub. Date: Jul. 17, 2025

(54) INTERACTIVE CHECKOUT SYSTEMS AND METHODS

(71) Applicant: KwikKart Corporation, Berkeley, CA (US)

(72) Inventor: Aaron S. Gyure, Austin, TX (US)

(21) Appl. No.: 19/018,516

(22) Filed: Jan. 13, 2025

Related U.S. Application Data
(60) Provisional application No. 63/620,809, filed on Jan. 13, 2024.

(51) Int. Cl. G06Q 20/20; G01G 19/52; G06Q 20/18; G06Q 30/0601

(52) U.S. Cl. CPC G06Q 20/208; G01G 19/52; G06Q 20/18; G06Q 30/0633

(57) ABSTRACT

A product checkout device operable to couple to a shopping cart and facilitate a checkout process for items placed in the shopping cart.

### RELATED APPLICATIONS

This application claims benefit of and priority to U.S. Provisional Patent application No. 63/620,809 titled “AUTOMATED CHECKOUT SYSTEM AND METHOD” and filed Jan. 13, 2024, which is hereby incorporated by reference in its entirety.

### FIELD

Embodiments relate generally to shopping devices and more particularly to smart shopping checkout systems and methods.

### BACKGROUND

Shopping in physical retail environments involves a complex interplay of activities, including product selection, assistance, checkout, and inventory management. Traditional systems often segregate these functions, relying on manual processes, isolated checkout stations, and separate security or inventory monitoring systems. The advent of automated checkout solutions has introduced technologies designed to streamline these operations, such as self-checkout kiosks, AI-powered cameras, and smart shopping carts.

### SUMMARY

Integrating checkout solutions into a cohesive, efficient framework remains a challenge, as many solutions are standalone, resource-intensive, or incompatible with existing retail environments. Traditional in-store retail experiences are characterized by fragmented and inefficient processes, with separate systems handling environment monitoring, checkout procedures, shopper assistance, and workflow management. Existing solutions, such as self-checkout kiosks, traditional cashier stations, and standalone camera or sensor systems for security and inventory monitoring, lack integration with advanced technologies to unify these functions. This disjointed approach leads to inefficiencies in store operations, suboptimal shopper experiences, and missed opportunities for leveraging data-driven insights and personalized digital media capabilities. Furthermore, these traditional systems often fail to adapt to evolving shopper expectations for seamless, technology-enhanced interactions.

Recent advancements in retail automation, such as smart shopping carts, AI-powered in-store camera systems, automated inventory management tools, and digital engagement platforms, aim to address these challenges. However, these innovations frequently fall short due to their inability to provide a single, compact, low-cost, and universally adaptable solution that integrates seamlessly into existing retail environments. Many of these systems require significant capital investments, infrastructural changes, or the introduction of large, standalone hardware components that disrupt standard store workflows. Additionally, some solutions depend on retailers supplying extensive upfront data or installing proprietary infrastructure, further limiting scalability and deployment in diverse retail formats.

As a result, retailers face significant barriers to adopting existing technologies at scale. These challenges include high upfront costs, the need to renovate or redesign store layouts, and the operational disruptions associated with implementing complex, standalone systems. For many retailers, these barriers lead to missed opportunities for increasing operational efficiency, enhancing customer engagement, and harnessing the full potential of data analytics. Addressing these limitations requires a transformative approach that integrates advanced technologies into a universally adaptable, cost-effective solution capable of delivering a unified, streamlined, and enhanced in-store retail experience.

Provided are embodiments of improved shopping checkout systems and methods. Certain embodiments employ Internet of Things (IoT) devices and systems, with a specific focus on technologies that integrate artificial intelligence (AI), machine learning (ML), and sensor-fusion systems to enhance in-store retail operations. For example, embodiments relate to smart checkout solutions, digital in-store media platforms, and automated environment monitoring systems that can provide seamless self-checkout processes, personalized shopper engagement, and real-time data-driven insights for store optimization. Embodiments span technological domains, including edge computing, computer vision, multi-modal sensor integration, advanced connectivity protocols (such as WIFI, LTE, and 5G), and AI-powered automation for theft prevention, inventory management, and shopper behavior analytics.

Certain embodiments are particularly well suited for applications in retail environments, including grocery stores, department stores, and specialty retail outlets, where they can address challenges such as improving operational efficiency, reducing checkout times, minimizing theft, and enabling hyper-personalized marketing. Additionally, certain embodiments employ adaptive IoT system design, for example, allowing aspects to be retrofitted into existing retail infrastructures with minimal disruption, offering flexibility and scalability across various retail formats. Various embodiments include interactive smart checkout devices for shopping carts and AI/ML-powered sensor-fusion IoT systems for enhanced in-store retail shopping, digital media, environment monitoring for data gathering, and seamless self-checkout techniques.

Provided in some embodiments is an AI/ML-powered sensor-fusion IoT device (referred to as an AI-powered interactive checkout device) and system designed to transform the in-store retail experience by integrating advanced technology into existing shopping carts and checkout environments. Such embodiments may provide a comprehensive solution that enhances the shopping journey, streamlines checkout operations, enables in-store environment monitoring for data-driven insights, and provides a hyper-personalized digital media channel. Such a system may, for example, be built around a compact, low-cost, and low-profile IoT device equipped with an AI-powered computer vision system, an ML-powered sensor-fusion system, a product barcode scanning system, and a high-accuracy weight system for weighing produce. In some embodiments, these aspects are housed in a device designed to attach to existing shopping carts using a universal clamping mechanism, ensuring compatibility with various cart designs across different retail formats.

In some embodiments, the IoT device includes a touchscreen interface for shopper interaction, an LED guidance system, and an onboard computer optimized for edge computing, enabling real-time processing and decision-making. In certain embodiments, the system is further supported by a customizable mobile charging station, which provides secure storage, automatic charging, and operational support for multiple devices. Such a charging station may be retrofitted into various retail settings, such as self-checkout zones or traditional checkout lanes, without requiring significant modifications to the store's infrastructure.

In some embodiments, cloud connectivity is employed, allowing the IoT devices and charging stations to communicate with a centralized cloud platform. Such a platform may integrate with existing retail systems, including POS, inventory management, and retail media networks, to ensure operational consistency and enable advanced functionality. Certain embodiments employ unique capabilities such as computer vision-powered anti-theft monitoring with real-time video segmentation and edge-analysis, computer vision-powered smart shelf monitoring for inventory and planogram compliance, and personalized shopper engagement through dynamic digital media and AI-powered assistance.

By addressing critical challenges such as checkout inefficiencies, theft, and inventory management, as well as unlocking massive revenue-driving capabilities through hyper-personalized digital media, embodiment may offer significant advantages over traditional self-checkout and smart cart systems. For example, it may incorporate a scalable, adaptable design that ensures compatibility with diverse retail environments, while its advanced technological features deliver a superior user experience, operational benefits, and a game-changing digital media channel that enables retailers and consumer brands to engage directly with shoppers in the aisles. Embodiments may, in turn, provide a transformative step forward in retail automation, combining innovation, efficiency, and user-focused design to redefine the modern shopping experience.

Provided in some embodiments is an interactive checkout system including: a checkout device adapted to couple to a shopping cart, the checkout device including: a processor; computer vision camera system adapted to identify unscanned items; a user interface including a touchscreen adapted to receive user input; an attachment mechanism adapted to secure the checkout device to the shopping cart; and a weight system adapted to weigh products, the weight system including a load cell system disposed between the touchscreen and the attachment mechanism that is adapted to sense weight of an item disposed on the touchscreen.

In some embodiments, a face of the touchscreen is planar and is adapted to rotate between a first position and a second position. In some embodiments, the face of the touchscreen is angled relative to horizontal in the first position, and the face of the touchscreen is oriented horizontally in the second position, and wherein the load cell system is adapted to sense weight of an item disposed on the face of the touchscreen oriented in the second position. In some embodiments, the weight system includes a rotation mechanism to rotate the face of the touchscreen between the first position and the second position. In some embodiments, the rotation mechanism is operable to rotate the face of the touchscreen between the first position and the second position responsive to a user input provided by way of the face of the touchscreen. In some embodiments, the rotation mechanism includes a motor. In some embodiments, the touchscreen is square or rectangular in shape and the load cell system includes a load cell disposed proximate to each corner of the touchscreen. In some embodiments, the checkout device includes a cart sensor system adapted to detect objects entering a basket of the shopping cart. In some embodiments, the cart sensor system includes time of flight (ToF) sensors adapted to detect items being placed into the cart.

Provided in some embodiments is a system including: a product scanning device that is adapted to attach to a shopping cart, for use in automating a checkout process for items placed in the shopping cart, the product scanning device including: a clamp adapted to enable coupling of the scanning device to the shopping cart; mapping sensors adapted to sense physical characteristics of the shopping cart, where the physical characteristics sensed are used to generate a mapping of a volume of the shopping cart; a wireless communication system adapted to enable wireless communication of data to a cloud platform for processing; a near filed communication (NFC) system adapted to enable wireless communication of data to a user device; a barcode scanner adapted scan product bar codes and transmit corresponding product information to the cloud platform via the wireless communication system or near filed communication with the user device; a camera system adapted to acquire images of products being scanned or placed into the shopping cart, wherein the images are preprocessed and uploaded to the cloud platform for processing via the wireless communication system or near filed communication with the user device; and a status indicator adapted to indicate a shopping status associated with the shopping cart. In some embodiments, the cloud platform is adapted to process uploaded images of products being scanned or placed into the shopping cart, to verify an identity of the product. In some embodiments, verification includes comparison of the acquired image of a product to known images of the product. In some embodiments, the cloud platform is adapted to process payments for products. In some embodiments, processing payments for products includes tracking products that are placed into a shopping cart by a user, and transferring funds from an account associated with the user to a store where the products are obtained from. In some embodiments, the user device employs a user application that is operable to communicate information to the user and to the product scanning device. In some embodiments, the user application provides an identity of the user for allocating charges for products, and presents, via the user device, information concerning the products that have been placed in the shopping cart.

Provided in some embodiments is a system including: a product scanning system that is integrated into the device adapted to attach to a shopping cart, for use in automating a checkout process for items placed in the shopping cart, the product scanning device including: a clamp adapted to enable coupling of the scanning device to the shopping cart; mapping sensors adapted to sense physical characteristics of the shopping cart and surrounding environment, where the physical characteristics sensed are used to generate a three dimensional mapping of the volume of the shopping cart and the environment surrounding the shopping cart; a wireless communication system adapted to enable wireless communication of data to a cloud platform for processing; a near filed communication (NFC) system adapted to enable wireless communication of data to a user device; a barcode scanning system adapted to scan product barcodes and transmit corresponding product information to and from the cloud platform via the wireless communication system or near filed communication with the user device; a camera system adapted to scan product barcodes, utilize AI-powered computer vision and machine learning-powered sensor technology to track the spatial location of items (products, objects, etc.) that enter the general vicinity of the shopping cart environment (ex, a few feet from the cart, inside the cart basket, etc.), identify tracked-items with corresponding labels (ex, scanned-item with product information, non-scanned/unidentified item, item in shopper hand, item on shelf, item in cart basket, etc.), acquire images of products being scanned or placed into the shopping cart, and enable data (ex, images, videos, etc.) to be preprocessed and uploaded to the cloud platform for additional processing and operational procedures via the wireless communication system or near filed communication with the user device; and a status indicator adapted to indicate a shopping status associated with the shopping cart. In some embodiments, the cloud platform and edge computing system integrated into the device are adapted to process images of products being scanned or placed into the shopping cart, to verify an identity of the product. In some embodiments, verification includes: spatial tracking and labelling of products that enter the shopping cart environment, and comparison of the acquired images of a product to known images of the product. In some embodiments, the cloud platform is adapted to process payments for products. In some embodiments, processing payments for products includes tracking products that are placed into a shopping cart by a user, and transferring funds from an account associated with the user to a store where the products are obtained from. In some embodiments, the user device employs a user application that is operable to communicate information to the user and to the product scanning device. In some embodiments, the user application provides an identity of the user for allocating charges for products, and presents, via the user device, information concerning the products that have been placed in the shopping cart.

### BRIEF DESCRIPTION OF THE DRAWINGS

FIGS. 1A and 1B are diagrams that illustrate overall system architecture in accordance with one or more embodiments.

FIGS. 2A and 2B are diagrams that illustrate a device perspective view in accordance with one or more embodiments.

FIGS. 3A and 3B are diagrams that illustrate a universal attachment mechanism in accordance with one or more embodiments.

FIGS. 4A-4C are diagrams that illustrate an integrated weight system in accordance with one or more embodiments.

FIGS. 5A-5C are diagrams that illustrate a computer vision system in accordance with one or more embodiments.

FIGS. 6A-6C are diagrams that illustrate a sensor-fusion system in accordance with one or more embodiments.

FIGS. 7A-7C are diagrams that illustrate a mobile charging station in accordance with one or more embodiments.

FIG. 8 is a diagram that illustrates an example computer system in accordance with one or more embodiments.

While this disclosure is susceptible to various modifications and alternative forms, specific example embodiments are shown and described. The drawings may not be to scale. The drawings and the detailed description are not intended to limit the disclosure to the form disclosed, but are intended to disclose modifications, equivalents, and alternatives falling within the spirit and scope of the present disclosure as defined by the claims.

### DETAILED DESCRIPTION

Described are embodiments of shopping checkout systems and methods. Certain embodiments employ Internet of Things (IoT) devices and systems, with a specific focus on technologies that integrate artificial intelligence (AI), machine learning (ML), and sensor-fusion systems to enhance in-store retail operations. For example, embodiments relate to smart checkout solutions, digital in-store media platforms, and automated environment monitoring systems that can provide seamless self-checkout processes, personalized shopper engagement, and real-time data-driven insights for store optimization. Embodiments span technological domains, including edge computing, computer vision, multi-modal sensor integration, advanced connectivity protocols (such as WIFI, LTE, and 5G), and AI-powered automation for theft prevention, inventory management, and shopper behavior analytics.

Certain embodiments are particularly well suited for applications in retail environments, including grocery stores, department stores, and specialty retail outlets, where they can address challenges such as improving operational efficiency, reducing checkout times, minimizing theft, and enabling hyper-personalized marketing. Additionally, certain embodiments employ adaptive IoT system design, for example, allowing aspects to be retrofitted into existing retail infrastructures with minimal disruption, offering flexibility and scalability across various retail formats. Various embodiments include interactive smart checkout devices for shopping carts and AI/ML-powered sensor-fusion IoT systems for enhanced in-store retail shopping, digital media, environment monitoring for data gathering, and seamless self-checkout techniques.

Provided in some embodiments is an AI/ML-powered sensor-fusion IoT device (referred to as an AI-powered interactive checkout device) and system designed to transform the in-store retail experience by integrating advanced technology into existing shopping carts and checkout environments. Such embodiments may provide a comprehensive solution that enhances the shopping journey, streamlines checkout operations, enables in-store environment monitoring for data-driven insights, and provides a hyper-personalized digital media channel. Such a system may, for example, be built around a compact, low-cost, and low-profile IoT device equipped with an AI-powered computer vision system, an ML-powered sensor-fusion system, a product barcode scanning system, and a high-accuracy weight system for weighing produce. In some embodiments, these aspects are housed in a device designed to attach to existing shopping carts using a universal clamping mechanism, ensuring compatibility with various cart designs across different retail formats.

In some embodiments, the IoT device includes a touchscreen interface for shopper interaction, an LED guidance system, and an onboard computer optimized for edge computing, enabling real-time processing and decision-making. In certain embodiments, the system is further supported by a customizable mobile charging station, which provides secure storage, automatic charging, and operational support for multiple devices. Such a charging station may be retrofitted into various retail settings, such as self-checkout zones or traditional checkout lanes, without requiring significant modifications to the store's infrastructure.

In some embodiments, cloud connectivity is employed, allowing the IoT devices and charging stations to communicate with a centralized cloud platform. Such a platform may integrate with existing retail systems, including POS, inventory management, and retail media networks, to ensure operational consistency and enable advanced functionality. Certain embodiments employ unique capabilities such as computer vision-powered anti-theft monitoring with real-time video segmentation and edge-analysis, computer vision-powered smart shelf monitoring for inventory and planogram compliance, and personalized shopper engagement through dynamic digital media and AI-powered assistance.

By addressing critical challenges such as checkout inefficiencies, theft, and inventory management, as well as unlocking massive revenue-driving capabilities through hyper-personalized digital media, embodiment may offer significant advantages over traditional self-checkout and smart cart systems. For example, it may incorporate a scalable, adaptable design that ensures compatibility with diverse retail environments, while its advanced technological features deliver a superior user experience, operational benefits, and a game-changing digital media channel that enables retailers and consumer brands to engage directly with shoppers in the aisles. Embodiments may, in turn, provide a transformative step forward in retail automation, combining innovation, efficiency, and user-focused design to redefine the modern shopping experience.

In some embodiments, provided is a smart interactive checkout device with a state-of-the-art IoT system designed to enhance the in-store retail experience. Certain devices combine advanced hardware and software technologies to deliver a seamless self-checkout process, enable hyper-personalized digital media capabilities, and automate retail environment monitoring for data-driven store optimization. Embodiments provide a system architecture that is engineered, integrating a suite of components that works to enhance operational efficiency and shopper engagement.

In some embodiments, the smart interactive checkout device includes a high-performance central processing unit (CPU) optimized for edge computing, enabling real-time data processing and minimizing latency for critical operations. An AI-powered computer vision system that incorporates advanced neural network models and a 360° camera array, providing comprehensive coverage for object recognition, theft prevention, and shopper behavior analysis. Further, a machine learning (ML)-powered sensor-fusion system intelligently combines data from motion, proximity, and environmental sensors to trigger context-aware actions, such as activating the camera or adapting the user interface.

In some embodiments, a high-accuracy weight system is integrated into the touchscreen interface, which allows users to weigh items directly on the device. Utilizing precision-engineered load cells, advanced pressure-sensing technology, and automated screen adjustment mechanisms, the system ensures accurate and fast weight measurements compliant with regulatory standards. In some embodiments, a universal clamping mechanism facilitates easy installation and secure attachment to a wide range of shopping cart handlebars, providing flexibility and stability across various cart designs.

In some embodiments, the device also incorporates a high-speed barcode scanning system for efficient product identification, a video processing system for capturing and analyzing shopper interactions, and an intuitive touchscreen interface coupled with robust firmware/software applications. These features may enable a wide array of functionalities, including seamless self-checkout, personalized promotions, interactive navigation assistance, and digital features to enhance the in-store user experience. An integrated location-sensing system, leveraging WiFi, Bluetooth Low Energy (BLE) beacons, and other technologies, may provide precise cart positioning within the store, unlocking location-based experiences and facilitating store analytics.

In some embodiments, connectivity is provided through a multi-channel communication system, including WIFI, LTE, and 5G, which can provide data transmission to a cloud-based platform regardless of network variability. This cloud platform may host a suite of products, offering features such as advanced in-store inventory management, shopper behavior analytics, employee optimization tools, and hyper-personalized digital media management for retailers and brands.

In some embodiments, the smart interactive checkout device is a comprehensive, intelligent solution that merges technologies to enhance the shopper experience while enabling retailers to optimize store operations, gain valuable insights, and enable hyper-personalized digital media to drive revenue. Its innovative design and integrated features may provide a transformative tool for modern retail environments.

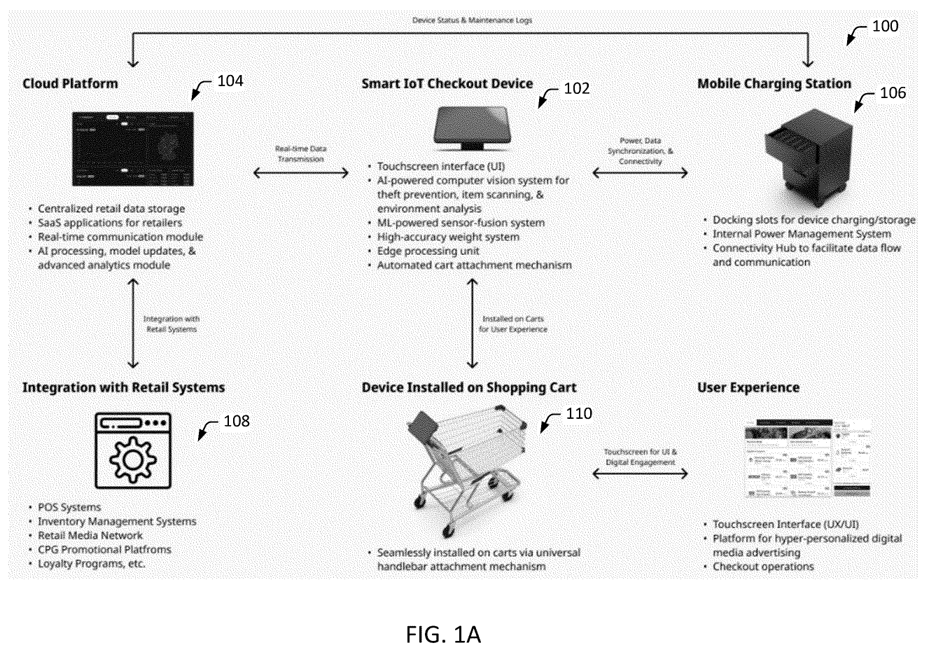

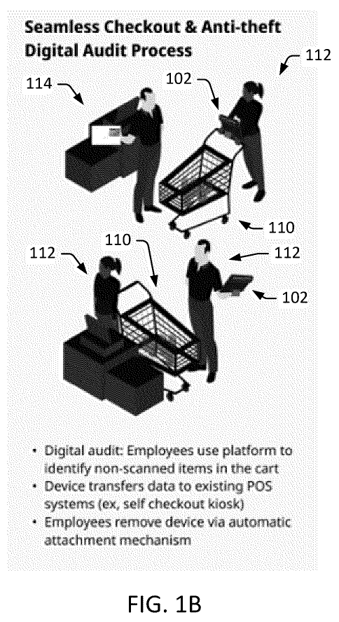

FIGS. 1A and 1B are diagrams that illustrate overall system architecture (“system”) 100 in accordance with one or more embodiments. The system 100 includes a smart IoT checkout device (or “device”) 102, a cloud platform 104, and a mobile charging station 106. The device 102 and other elements of the system 100 may be integrated with retail systems 108 via the cloud platform 104. The device 102 may be installed on a shopping cart system 110 or the like, where it is operable to provide for use and interaction by users 112 to provide a corresponding user experience in a shopping environment 114 or the like. The device 102 associated elements and processes described here may provide for enhanced shopping and checkout operations, as well as enhance security (e.g., by way of ant-theft digital audit processes).

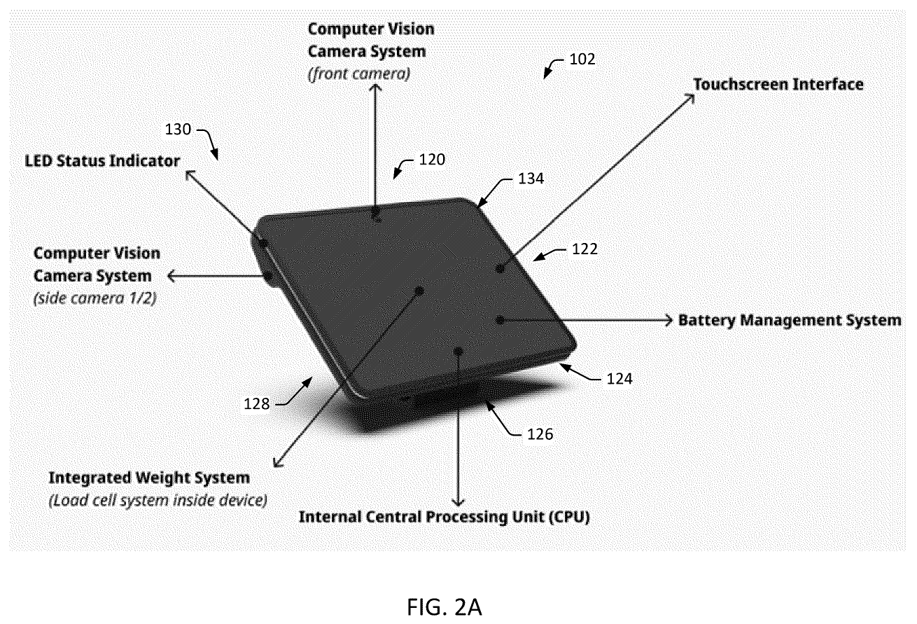

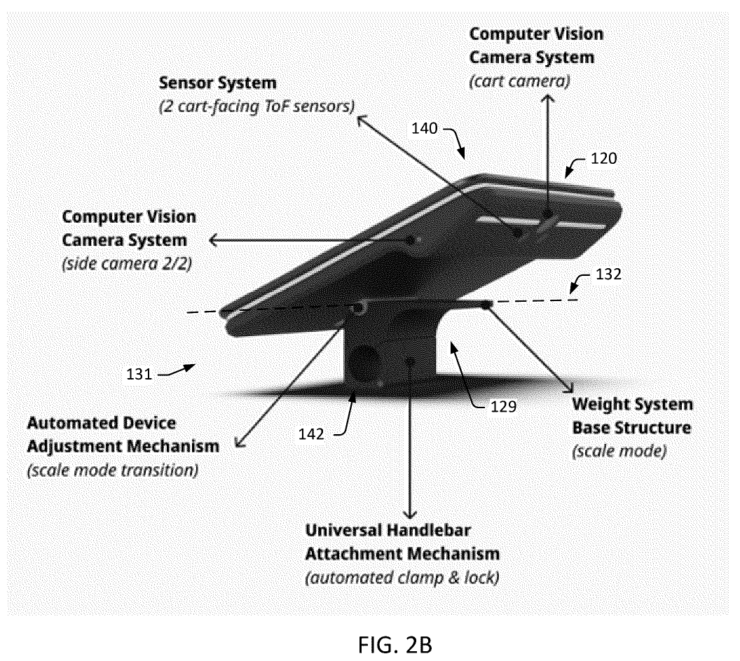

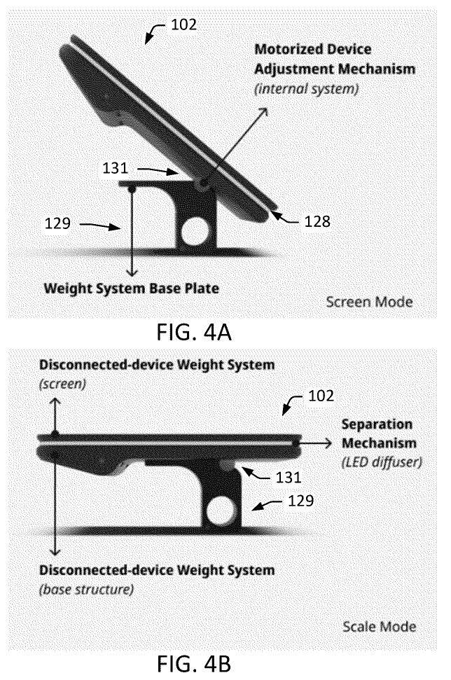

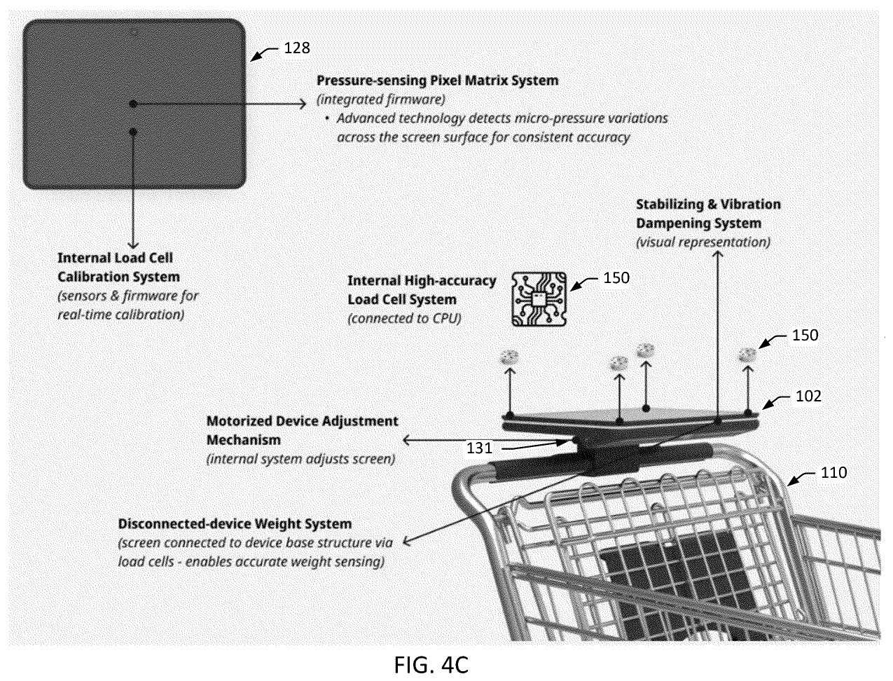

FIGS. 2A and 2B are diagrams that illustrate a device 102 perspective view in accordance with one or more embodiments. As illustrated, the device 102 may include a camera system (e.g., a camera vision system that includes front and side cameras, where the front camera is a “cart” camera that is operable to capture images of the basket area of the shopping cart 110) 120, a user interface (e.g., a touchscreen interface) 122, a power management system (e.g., a battery management system) 124, a processor (e.g., an internal central processing unit (CPU)), a weight system (e.g., an integrated weight system that includes a load cell integrated in the device 102, between the touchscreen 122 and a base structure 129 thereof) to measure weight of objects placed on the touchscreen interface) 128, a status indicator (e.g., a LED status indicator) 130, and a rotation mechanism 131 to provide for rotation of the unit. The rotation mechanism 131 may be an automated device adjustment mechanism, such as a motor to provide for pivoting rotation of the touchscreen 122 about a horizontally oriented pivot axis 132 to provide for rotating of the touchscreen 122 relative to the base structure 129, where the touchscreen 122 may be rotated between positions angled relative to horizontal, where a face 134 of the touchscreen 122 is oriented for case of viewing by a user 112 (e.g., as shown in FIG. 4A), to a weighing position (e.g., as shown in FIG. 4B), that includes the face 134 of the touchscreen 122 oriented horizontally to provide for weighing of products—this may include the touchscreen 122 oriented in a “flat” position to enable users to place products on the face 134 of the touchscreen 122, where the product can be weighed by way of the load cell integrated in the device 102, between the touchscreen 122 and a base structure 129 thereof (e.g., a matrix of four integrated load cells 150 disposed at the corners of the device, touchscreen 122 and base structure 129). The device 120 may include a sensor system (e.g., including cart time of flight (ToF) sensors to detect items placed into the shopping cart 110) 140, and an attachment mechanism (e.g., a universal handlebar attachment mechanism, including an automated clamp and lock, that is operable to secure the device 120 to a handle of a shopping cart 110) 142.

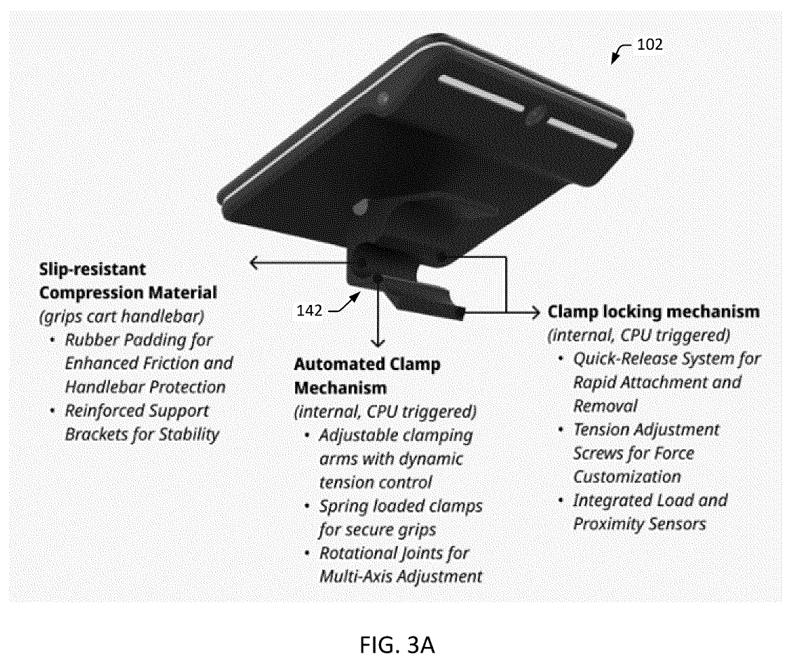

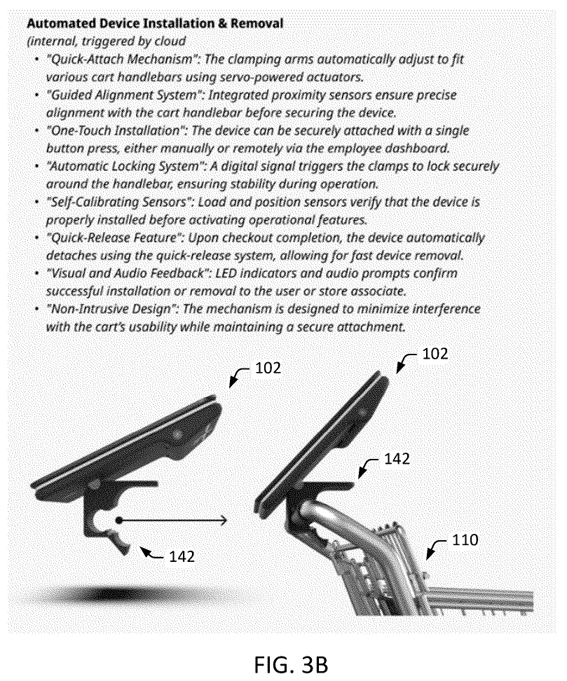

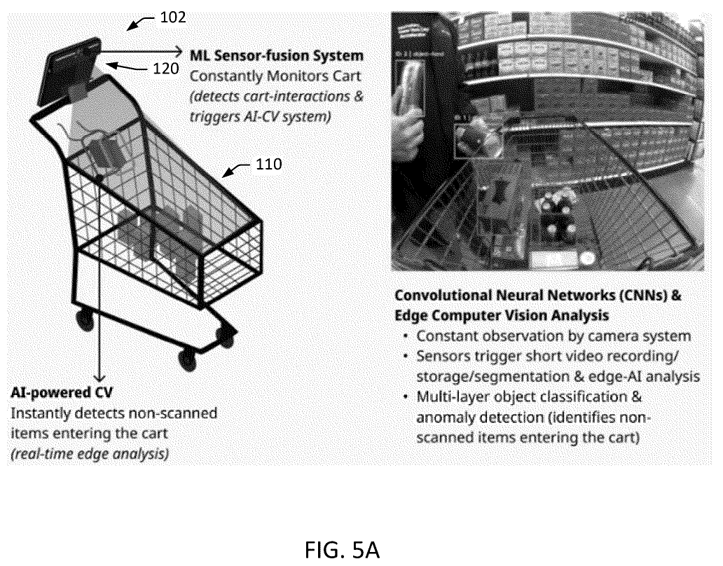

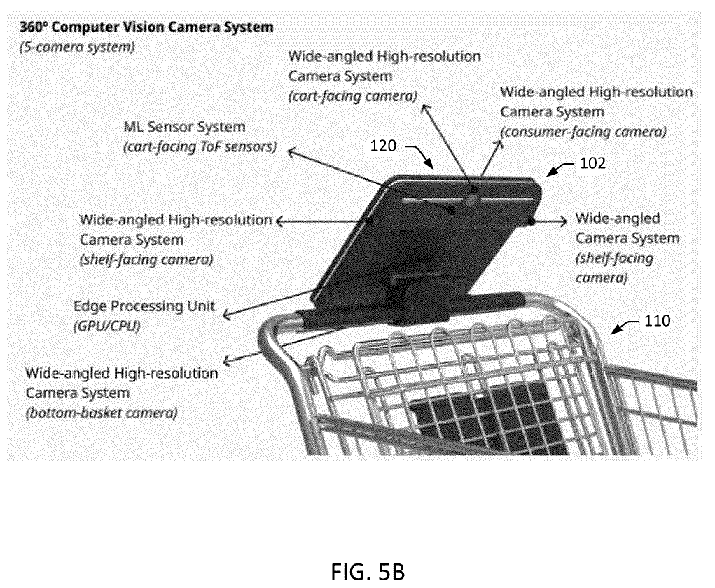

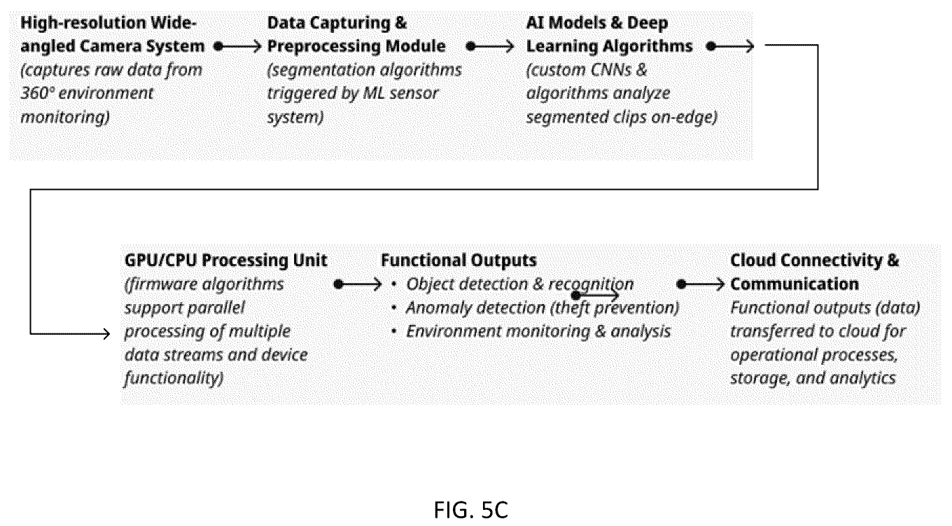

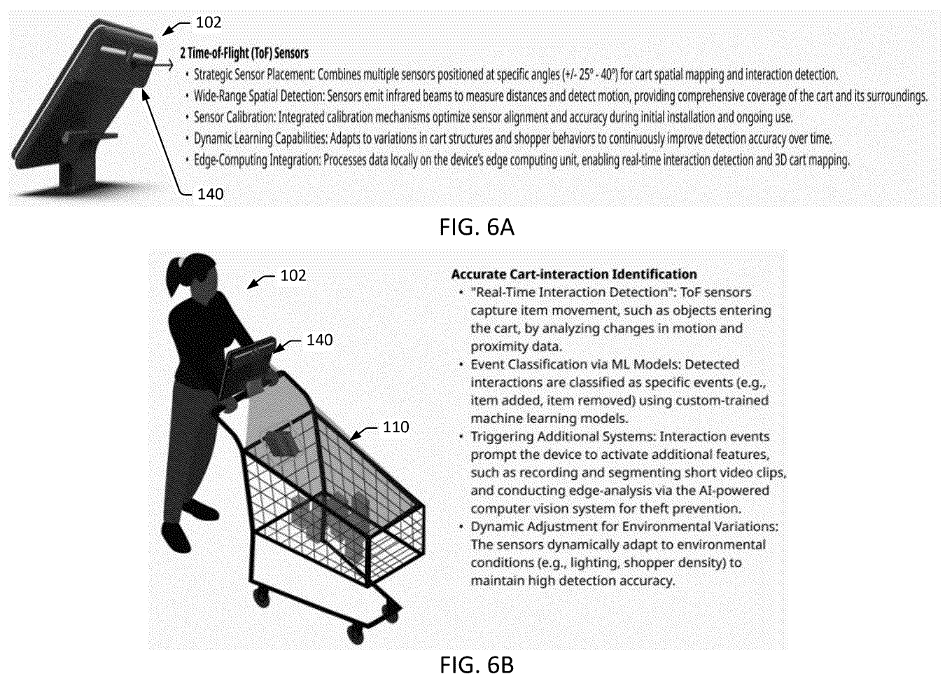

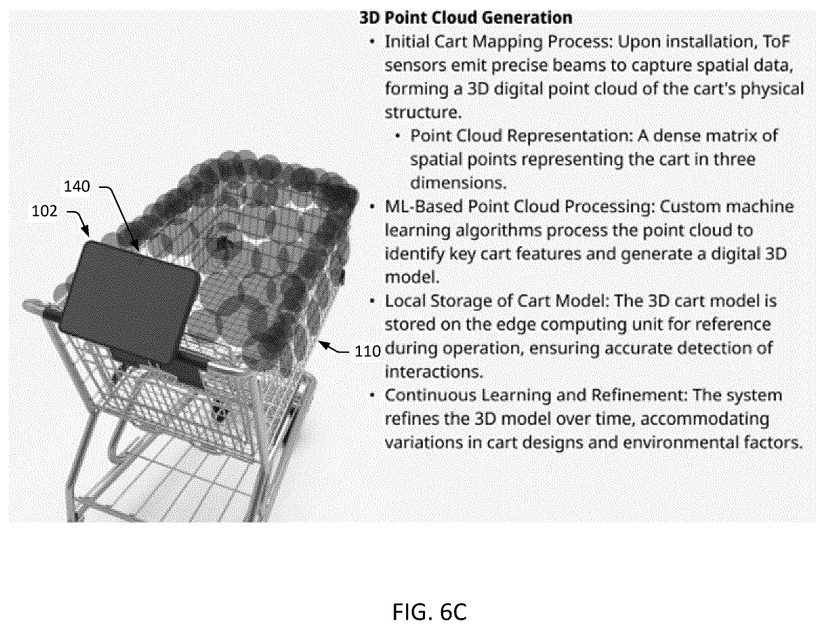

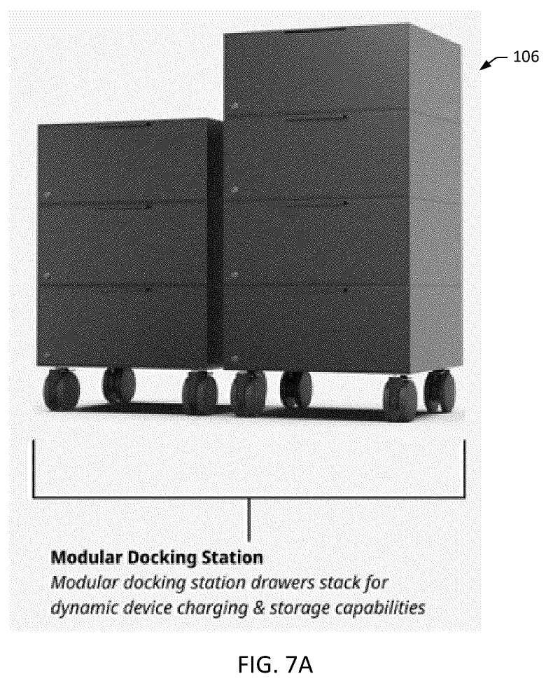

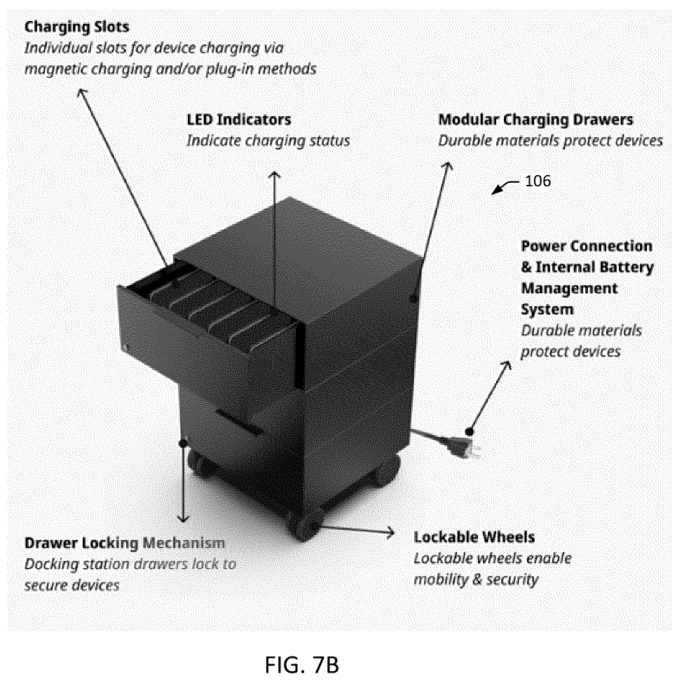

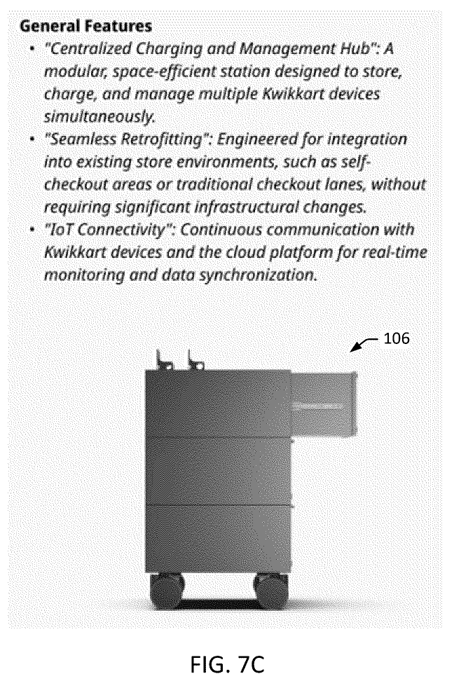

FIGS. 3A and 3B are diagrams that illustrate a universal attachment mechanism 142 in accordance with one or more embodiments. FIGS. 4A-4C are diagrams that illustrate an integrated weight system 128 in accordance with one or more embodiments. FIGS. 5A-5C are diagrams that illustrate a computer vision system 120 in accordance with one or more embodiments. FIGS. 6A-6C are diagrams that illustrate a sensor-fusion system 140 in accordance with one or more embodiments. FIGS. 7A-7C are diagrams that illustrate a mobile charging station 106 in accordance with one or more embodiments.

### Interactive Smart Checkout Device Components

### ML-Powered Sensor-Fusion System

In some embodiment, the ML-powered sensor-fusion system 140 is a component of the smart IoT checkout device 102, designed to leverage advanced motion and proximity sensors to accurately define the physical structure of a shopping cart 110 and detect shopper interactions in real-time. This system may employ a network of specifically arranged time-of-flight (ToF) sensors XX that emit precise beams to capture spatial data about the shopping cart's physical structure upon device installation. During the initial mapping process, the ToF sensors emit infrared rays that detect surfaces, contours, and dimensions of the shopping cart. The data collected forms a detailed point cloud—a matrix of spatial points—that digitally represents the cart in three dimensions.

In some embodiments, a machine learning algorithm processes the point cloud data, identifying key structural features of the cart, such as the handlebar, basket, and edges, and creates a digital 3D model. This model is stored locally on the device's edge-computing unit and serves as a reference for subsequent operations. The system continues to refine this model over time, adapting to subtle variations in cart structure across different installations, further enhancing its accuracy.

In some embodiments, once the cart structure is mapped, the ToF sensors operate in real-time to detect shopper interactions, such as objects entering or exiting the shopping cart, as well as the general shopping cart environment. The system may use continuous ToF sensor data to monitor motion and proximity changes, identifying events such as a shopper placing an item into the cart, removing an item from the cart, moving items within the cart, or items entering the general vicinity of the shopping cart environment. In some embodiments, these interactions trigger advanced machine learning algorithms to classify and analyze the detected events. For example, if an object enters the cart without being scanned, the system flags the interaction and prompts the computer vision camera system to record, segment, and process a short video clip of the event.

In some embodiments, the system's edge-computing unit processes and stores these video clips using a video segmentation and processing subsystem. The clips may be analyzed locally to determine the nature of the interaction (e.g., whether it corresponds to a legitimate or unauthorized action). In some embodiments, this data is subsequently stored securely and synchronized with the cloud platform for further analysis, enabling retailers to monitor and respond to shopper behaviors while ensuring operational security.

In some embodiments, the ML-powered sensor-fusion system employs continuous operation and dynamic learning capabilities to help ensure that shopper interactions are captured with high accuracy and reliability. Its ability to map and monitor the cart in real-time may enhance the functionality of the IoT checkout device and support advanced features like theft prevention, shopper behavior analysis, and data-driven store optimization. By integrating cutting-edge ToF sensors, machine learning algorithms, and edge-computing technologies, this system may provide intelligence.

### AI-Powered Computer Vision Camera System

In some embodiments, the AI-powered computer vision camera system 120 is an integrated component of the smart IoT checkout device 102, for example, combining advanced artificial intelligence models, high-resolution camera technology, and integrated processing hardware to enable real-time visual analysis of the in-store retail environment 114. In some embodiments, the system is built upon custom-developed AI models leveraging deep learning techniques, such as convolutional neural networks (CNNs) and algorithms trained on custom-annotated datasets to achieve high accuracy in object detection, product recognition, and behavior analysis. These models may be specifically optimized for the dynamic and diverse scenarios encountered in retail environments.

In some embodiments, the camera system incorporates multiple high-resolution, wide-angled cameras strategically integrated into the device to provide comprehensive 360° coverage of the shopping cart, surrounding store aisles, shelving, and other key areas. The cameras may be designed to operate under varying lighting conditions, ensuring consistent performance in both brightly lit and dimly lit environments. In some embodiments, the data captured by these cameras is processed in real-time by an integrated GPU/CPU processing unit, which may be optimized for parallel processing of visual data, enabling efficient execution of deep learning inference tasks.

In some embodiments, the AI-powered computer vision system performs multiple functions to enhance the retail experience and operational efficiency. For shopper interactions, it detects and analyzes user behaviors, such as adding items to the cart or interacting with store products, to provide insights into shopping patterns and preferences. The system also plays a critical role in scanning procedures, utilizing object detection and product recognition capabilities to accurately identify items, match them to their respective barcodes or SKUs, label items that enter the shopping carts physical environment based on whether they have been scanned or not, label items that enter the shopping carts physical environment based on the items location (ex, in the shoppers hand, on the shelf, inside the shopping cart area), and continuously track labelled items to identify when their states change in order to accurately update their labels. Furthermore, the cameras continuously monitor the shopping cart to detect anomalies, such as unscanned items, and record, store, and preprocess short video clips of these events for review by store associates, thereby contributing to theft prevention and loss reduction.

In some embodiments, beyond cart-level analysis, the system captures detailed visual data about the retail environment, including aisle configurations, shelf inventory, and customer foot traffic. This data may be processed to generate actionable insights for store optimization, such as identifying high-traffic areas, monitoring inventory levels, and assessing product placement effectiveness.

Additional features of the system may, for example, include:

Custom Camera Calibration: providing precise alignment and minimal distortion for accurate data capture across the entire field of view.

Real-Time Edge Processing: providing for immediate analysis of visual data on the device, reducing latency and minimizing the need for constant cloud connectivity.

Dynamic Adaptation: providing for adjusting parameters dynamically based on environmental conditions, such as lighting or shopper density, to maintain optimal performance.

Integrated Security Features: providing data integrity and privacy through encrypted storage and transmission of visual data.

Such an integrated system of custom AI models, high-resolution cameras, and robust processing hardware enables the device to deliver unparalleled functionality in monitoring, analyzing, and optimizing the retail experience. By combining innovative technologies with a practical design, the AI-powered computer vision camera system exemplifies the transformative potential of artificial intelligence in the retail sector.

### In-Store Location-Sensing System

In some embodiments, the in-store location-sensing system (part of sensor system 140) is integrated in the IoT checkout device 102 and its broader IoT ecosystem, and is designed to provide precise, real-time tracking of the shopping cart's 110 position within a grocery store environment 114. Such a system may integrate multiple advanced technologies, including WiFi-based location sensing, Bluetooth beacons, and Bluetooth Low Energy (BLE) technology, to create a robust and redundant network for high-accuracy location determination. In some embodiments, WiFi location-sensing technology uses existing store WiFi infrastructure and access points to estimate the device's position based on signal strength (RSSI), time of flight (ToF), and advanced triangulation algorithms. These techniques may allow for scalable and cost-effective positioning, leveraging the infrastructure already present in most modern retail environments.

In some embodiments, in addition to WiFi, the system incorporates BLE technology via strategically placed beacons throughout the store. The IoT checkout device may be equipped with a BLE receiver that scans and analyzes signals from these beacons, enabling precise triangulation based on signal strength and proximity. In some embodiments, to further refine positional accuracy, the system integrates accelerometers and gyroscopes, which provide inertial data to track cart movement and orientation dynamically. These sensors ensure smooth and reliable tracking, even in areas where wireless signal strength may fluctuate, such as crowded or signal-blocked aisles.

In some embodiments, the device combines these inputs with additional store-specific data, such as digital planograms and predefined geofences, to map the cart's position relative to store layouts, shelving, and key locations. This real-time location data may enables a wide array of user-facing features, including personalized navigation assistance that guides shoppers to specific aisles or products, context-aware promotions triggered by the shopper's proximity to relevant items, and interactive store maps that enhance the overall shopping experience.

In some embodiments, simultaneously, the system supports advanced environment monitoring and data analytics. By tracking cart movements and identifying high-traffic areas, the system may enable retailers to analyze shopper behavior, optimize store layouts, and evaluate the effectiveness of product placements. In some embodiments, this data is continuously transmitted via the device's multi-channel communication system, including WiFi and, when necessary, cellular networks like LTE or 5G, ensuring seamless connectivity with a cloud-based analytics platform. The platform may process and synthesize the data to generate actionable insights, such as peak traffic zones, shopper flow patterns, and inventory management recommendations.

In some embodiments, to ensure reliability and accuracy, the location-sensing system dynamically selects the best connectivity and positioning method based on environmental factors, such as signal quality and shopper density. By combining WiFi location-sensing, BLE technology, and advanced inertial sensing, the system may deliver precision and robustness, ensuring the IoT checkout device functions effectively in diverse retail environments. This integrated approach may enhance shopper experience, streamline operations, and provide retailers with critical insights for data-driven decision-making, positioning the platform as a transformative solution in the retail technology landscape.

### Universal Shopping Cart Attachment Mechanism

In some embodiments, the universal automated clamping mechanism 142 is a component of the smart IoT checkout device 102, to securely and efficiently attach the device to a wide range of shopping cart handlebars while enabling quick and seamless removal when required. This mechanism may combine a range of advanced mechanical and digital components to provide a versatile, secure, and user-friendly solution that enhances both functionality and operational efficiency. In some embodiments, the mechanism features adjustable clamping arms with dynamic tension control, allowing it to adapt to shopping carts of various sizes and designs. These arms may be constructed from lightweight, high-strength materials such as aluminum alloys or reinforced polymers, ensuring durability and ease of use.

In some embodiments, the clamping arms are paired with spring-loaded clamps, which provide a firm grip on the handlebars while accommodating variations in shape and diameter. The system may include rotational joints that allow for multi-axis adjustment, enabling precise alignment and stability during installation. In some embodiments, to facilitate rapid attachment and removal, the mechanism incorporates a quick-release system powered by servo motors and actuators, which can be triggered manually or digitally. This quick-release mechanism may be synchronized with the onboard processing unit of the IoT device, enabling remote or automated unlocking based on predefined workflows, such as when a shopper completes the checkout process.

In some embodiments, the mounting plate, which can serve as the interface between the device and the cart, is designed with pre-drilled slots and cushioned backing to ensure secure and vibration-free attachment. Tension adjustment screws with knurled heads may be provided to allow for fine-tuning of clamping force, ensuring compatibility with a wide range of cart handlebar designs. In some embodiments, rubber padding and grips are integrated into the contact surfaces of the clamping arms and clamps to enhance friction, prevent slippage, and protect the handlebars from damage.

In some embodiments, to further enhance stability and distribute load evenly, the mechanism includes support brackets that securely anchor the device to the cart. These brackets may be adjustable and reinforced to withstand the rigors of daily use in high-traffic retail environments. In some embodiments, the entire clamping mechanism is designed to interact seamlessly with the device's onboard firmware, which monitors the clamping system's status and ensures optimal performance through self-calibration and diagnostics.

In some embodiments, the universal clamping mechanism also includes integrated sensors and feedback systems to monitor the device's attachment status in real-time. For example, load sensors detect whether the device is securely attached to the cart, while proximity sensors ensure proper alignment during installation. This data is communicated to the onboard processing unit and, if necessary, transmitted to the cloud platform for remote monitoring and operational oversight.

In some embodiments, by combining these mechanical, electronic, and firmware-driven components, the universal clamping mechanism helps to ensure that the IoT checkout device can be securely installed and removed with minimal effort and maximum reliability. This innovative design may enhance the user experience and streamline store operations, enabling retailers to efficiently deploy and manage the devices across a diverse range of shopping carts.

### Product Barcode Scanning System

In some embodiments, the product barcode scanning system (part of sensor system 140) is an integrated component of the IoT checkout device 102 and is designed to enable rapid and accurate product identification during the shopping process while integrating seamlessly with the device's broader hardware and software ecosystem. This system may employ a combination of high-speed laser scanners and software-based camera barcode scanning technologies, allowing it to detect and read product barcodes on items as they are added to the shopping cart. In some embodiments, the system's hybrid design ensures optimal performance, enabling it to handle various barcode types and orientations in dynamic retail environments.

In some embodiments, the barcode scanning system is integrated with the AI-powered computer vision camera system, which enhances its ability to locate and focus on barcodes even in challenging scenarios, such as low-light conditions or partially obstructed barcodes. This integration may be further augmented by the ML-powered sensor-fusion system, which uses input from motion sensors and time-of-flight (ToF) sensors to detect the movement of items toward the cart and activate the barcode scanner at the optimal moment. In some embodiments, this coordination ensures accuracy and efficiency in capturing barcode data, minimizing errors and reducing scanning delays.

In some embodiments, the scanned barcode data is processed in real-time by the device's onboard computer, which features a GPU/CPU processing unit optimized for edge computing tasks. The system may cross-references barcode data with product databases stored locally or accessed via the cloud platform. This functionality may allow for instant retrieval of product information, including pricing, descriptions, and promotions, enhancing the shopper's experience. Additionally, the system's integration with the cloud platform may enable seamless communication with retail POS and inventory management systems, ensuring accurate inventory tracking and pricing consistency.

In some embodiments, beyond standard product identification, the barcode scanning system is designed to identify anomalies and potential theft events. For example, if an item enters the shopping cart without being correctly scanned, the system, in coordination with the computer vision and sensor-fusion subsystems, may flag the event and record a short video clip for store associate review. This proactive monitoring capability may help reduce shrinkage and enhance store security without compromising the shopper experience.

In some embodiments, the barcode scanning system's hardware is designed for durability and precision, incorporating features such as multi-directional scanning to capture barcodes from various angles and adaptive focus technology to accommodate items at different distances. Its software components may include advanced algorithms for decoding damaged or faded barcodes, ensuring reliable performance across a wide range of product conditions.

In some embodiments, this integrated product barcode scanning system not only streamlines the shopping and checkout process but also enhances operational efficiency and security. By leveraging advanced scanning technologies, AI-driven computer vision, and seamless cloud integration, it may provide an element of the IoT device, delivering an intelligent and reliable solution for modern retail environments.

### Internal Video Capturing, Segmenting, and Condensing Process

In some embodiments, the internal video capturing, segmenting, and condensing process is a subsystem of the IoT checkout device 120, designed to capture, analyze, and store video data in real-time while optimizing storage and processing efficiency. This system may enable the device to document relevant events, such as shopping cart and retail environment interactions, by recording short, high-value video clips that are processed and analyzed using advanced AI models. The process may be engineered to ensure that critical interactions are accurately captured and stored while minimizing unnecessary data retention.

In some embodiments, the system leverages a continuously active camera network, which records video data during the device's operation. Advanced algorithms embedded within the firmware of the edge-processing unit may dynamically manage video segmentation, processing, and storage. In some embodiments, these algorithms are tightly integrated with the ML-powered sensor-fusion system, which provides real-time data to trigger the recording and segmentation processes. For example, when a shopper places an item in the cart, the sensor system detects the interaction and signals the camera system to retain the relevant video segment. To ensure comprehensive coverage, the camera system may store video data from a defined period of time prior to the event (e.g., 3 seconds) and a defined period after the event (e.g., 5 seconds), creating a complete context for the interaction.

In some embodiments, the segmentation system periodically deletes video data that does not include triggering events to significantly reduce the storage footprint on the device. This selective storage capability may be achieved using advanced video segmentation algorithms that identify and retain only relevant video clips. The segmented video data may be processed locally by a series of custom-built AI computer vision models, which analyze the video for key features such as item recognition, interaction anomalies, or potential theft events. These models operate within the AI-powered computer vision system, leveraging deep learning to identify patterns and derive actionable insights.

In some embodiments, once analyzed, the video clips are further condensed and labeled with metadata generated during the AI analysis. This metadata may include details such as the type of event, item identification, and any detected anomalies. In some embodiments, the labeled video clips are then transmitted to the cloud platform via the device's connectivity system, which supports multiple methods such as WIFI, LTE, and 5G to ensure reliable data transfer. In the cloud, the videos may be stored in labeled categories for further processing and operational use, such as review by store associates for theft detection or customer behavior analysis.

In some embodiments, the integrated functionality of the video-data processing system, segmentation and storage algorithms, IoT hardware, AI-powered computer vision models, and ML-powered sensor system ensures that the camera system operates efficiently while capturing all critical events. This comprehensive approach may significantly reduce storage requirements, enhance edge computing performance, and ensure the seamless capture, analysis, and documentation of relevant video data. By combining real-time processing with intelligent data management, this system may provide a reliable and scalable solution for retail operations and security with IoT video processing technology.

### Touchscreen Interface for User Experience and Functionality

In some embodiments, the touchscreen interface 122 of the smart IoT checkout device 102 serves as a central hub for both shoppers and retail operators, seamlessly integrating user experience (UX) and functional operations into a single interactive platform. This capacitive touchscreen may be designed to deliver an intuitive and engaging digital shopping experience, featuring a user-friendly UX/UI tailored for diverse in-store activities. In some embodiments, it is constructed with durable materials to withstand the demands of retail environments, and the interface is equipped with multi-touch capabilities, anti-glare coatings, and adaptive brightness to ensure optimal performance under various lighting conditions.

In some embodiments, the touchscreen interface provides a wide array of features designed to enhance and digitize the in-store shopping journey. Functionalities may, for example, include:

Item Scanning and Checkout/Payment Operations: enabling shoppers to seamlessly scan items, manage their cart, and complete payments directly through the interface, enabling a frictionless self-checkout process.

Digital Media Platform: operable to display personalized promotions, coupons, and discounts based on real-time location data and shopper profiles, leveraging in-store location-sensing and cloud-integrated shopper analytics.

AI-powered Shopping Assistant: an integrated chatbot employing advanced natural language processing (NLP) algorithms to assist shoppers with inquiries, provide product recommendations, and navigate the store.

Item-Finding and Inventory Search: enabling shoppers to locate items within the store and view real-time inventory status using location-based data integrated with the store's inventory management system.

Recipe Browsing and Personalization: an interface employing an online recipe platform that offers meal ideas and tailored suggestions based on shopper preferences and items scanned.

Advanced Product Information: enabling data from the device's sensor systems and cloud platform to provide detailed product insights, including nutritional information, sourcing, and sustainability details.

In some embodiments, in addition to shopper-focused features, the touchscreen interface supports key retail operations. It may enable store associates to manage device settings, monitor system status, and facilitate the checkout process when necessary. In some embodiments, during checkout, the interface assists associates in weighing produce, reviewing flagged events (e.g., potential theft), and processing payments efficiently. The interface may also provide real-time notifications about device performance, battery status, and connectivity, ensuring seamless operation and maintenance.

In some embodiments, the touchscreen interface is integrated with the device's hardware and software ecosystem. It may communicate with the central processing unit (CPU), cloud platform, and AI-powered systems, allowing for real-time updates and dynamic interaction. In some embodiments, advanced firmware ensures that the interface is responsive and adaptive, offering features such as personalized UI themes for individual shoppers and multi-language support to cater to diverse customer demographics.

By combining robust hardware, advanced software capabilities, and an intuitive design, the touchscreen interface of the IoT device transforms the in-store shopping experience while streamlining retail operations. Its integration of shopper engagement features and operational tools underscores its role as a versatile component of the system, bridging the gap between physical and digital retail environments.

### IoT Device and System Connectivity Methods

In some embodiments, the IoT device 102 and system's connectivity methods provide robust, reliable, and adaptive communication with its cloud platform, providing uninterrupted operation within diverse retail store environments. In some embodiments, a connectivity method is WIFI, which may support high-speed, real-time data transmission for seamless operation of critical device functions, including checkout procedures, user interface interactions, and environmental monitoring. Recognizing that WIFI coverage can be inconsistent in some retail settings, the system may be equipped with multiple alternative connectivity options, including 5G and LTE cellular networks. These cellular connections may provide a dynamic fallback mechanism, allowing the device to, for example, automatically transition between networks based on real-time assessments of signal strength and availability, helping to ensure continuous data flow even in challenging connectivity scenarios.

In some embodiments, to enhance local networking and support in-store IoT ecosystem synchronization, the device also incorporates additional wireless communication protocols such as Bluetooth, Zigbee, and potentially Thread. These protocols may facilitate low-power, short-range communication for tasks like syncing with other IoT devices, accessing in-store beacons, and enabling localized data sharing. This multi-layered connectivity architecture may ensure the device remains functional and integrated within the broader retail IoT environment, even when primary network connections are temporarily unavailable.

In some embodiments, the connectivity system is further supported by intelligent connectivity management software embedded within the device's firmware. This software may dynamically select the optimal network based on parameters such as signal strength, bandwidth requirements, latency tolerances, and operational priorities. In some embodiments, such as in instances where all network options are temporarily inaccessible, the system employs a secure local data storage solution, allowing the device to cache critical information such as transaction details, environmental monitoring data, and user interactions. In some embodiments, once a stable connection is re-established, the system automatically synchronizes the locally stored data with the cloud platform, ensuring that all information is up-to-date and available for analysis and operational use.

In some embodiments, this adaptive connectivity system is employed for maintaining the functionality and reliability of the IoT device. It may support essential operations, such as real-time data transmission for UX/UI features, cloud-based processing for AI models, and integration with retail POS and inventory management systems. Furthermore, it may enable the continuous reception of in-store data-driven insights, which are transmitted to the retail-facing online platform to provide valuable information for inventory management, shopper behavior analysis, and operational efficiency improvements.

By combining advanced hardware, multiple wireless protocols, intelligent connectivity management software, and local data redundancy, the IoT device and system may deliver a highly resilient and adaptable connectivity solution. This may ensure consistent functionality and a user experience, even in complex and variable retail network environments, while facilitating operations and data analytics for store optimization.

### IoT Mobile Charging Station & Checkout Operations Method

In some embodiments, the IoT mobile charging station and checkout operations system (106) is integrated into existing retail environments, such as checkout aisles, self-checkout areas, and designated device storage zones, e.g., without requiring significant modifications to the store layout. This system may function as the central hub for storing, automatically charging, and managing smart IoT checkout devices, while also supporting comprehensive checkout and store associate operations. In some embodiments, the charging station is equipped with multiple docking slots configured to securely accommodate and charge multiple IoT devices simultaneously, ensuring all units not actively in use are consistently powered and ready for deployment.

In some embodiments, such as when constructed with a modular, space-efficient design, the station can be retrofitted into various store configurations. Its components may include storage drawers for securely housing devices, integrated power management hardware for automatic charging, and connectivity features for maintaining device communication with the cloud platform. To enhance functionality, the station may be equipped with an employee interface, which may include tablets, monitors, or a central dashboard, allowing store associates to oversee the entire system and manage key operations.

### Example User Workflow:

In some embodiments, a user process includes the following operations:
1. Consumer Device Access: Shoppers enter the store and retrieve a shopping cart equipped with a device already installed on the handlebar. These carts may be located near the charging station or in designated storage areas, configured to meet the store's specific requirements.
2. In-Store Shopping and Checkout Preparation: As shoppers move through the store, the IoT device allows them to scan items, weigh produce, and access features like personalized promotions, store navigation, and product information. The device, connected to the cloud platform, streamlines the shopping process while simultaneously capturing and processing data related to shopper interactions, cart contents, and retail environment monitoring.
3. Checkout: Upon completing their shopping, consumers proceed to the checkout area, which may include the charging station, a self-checkout zone, or a dedicated checkout lane. Store associates use the system's employee interface to handle the checkout and audit process.
4. Anti-Theft Digital Audit: During the checkout process, store associates review the IoT device's anti-theft dashboard to address flagged events. The dashboard displays short video clips of detected anomalies, such as unscanned items entering the cart, which were recorded and processed by the device during the shopper's trip. Associates can verify the completeness of the purchase by scanning or weighing flagged items and finalizing any discrepancies.
5. Device Removal and Checkout Finalization: Once the audit is complete and all items are correctly scanned, the associate places the device in checkout mode via the employee interface. This action automatically unlocks the device from the shopping cart's handlebar and initiates a secure, encrypted data transfer through the cloud platform to the store's existing POS system. The final payment is processed, and the device is either returned to the charging station for recharging and storage or reinstalled onto another cart for the next customer.

### Example Features and Operational Benefits:

Secure Charging and Storage: Each docking slot within the charging station includes intelligent power management to prevent overcharging and optimize battery longevity, as well as physical security features to prevent unauthorized device removal.

Real-Time System Monitoring: The employee interface provides real-time insights into device status, charging levels, connectivity, and operational data, enabling efficient management of devices and workflows.

Seamless Integration with Store Systems: The station's cloud platform connectivity ensures that device data, including scanned items and checkout summaries, integrates directly with the store's POS and inventory systems for accurate and synchronized operations.

Scalability and Adaptability: The modular design supports scalability for stores of varying sizes, allowing for the addition or reconfiguration of docking slots and operational areas to meet changing store requirements.

By combining advanced device management, automated charging, and efficient checkout workflows, the IoT mobile charging station and checkout operations system may significantly enhance the functionality and usability of devices. This system may improve the shopper's experience through a streamlined process and optimize operational efficiency for retailers, ensuring a seamless and technologically advanced retail environment.

### High-Accuracy Integrated Load Cell and Weight System for Weighing Items

In some embodiments, the high-accuracy load cell system integrated into the AI-powered interactive smart checkout device provides enhancement in smart retail technology, for example, enabling shoppers to seamlessly weigh produce and pay-per-pound items directly on the screen of the device. This innovative system may help to merge advanced weight measurement capabilities with a user-friendly interface, significantly enhancing the functionality of the checkout device. In some embodiments, the system includes the screen (which functions as an interactive tablet) and the base (a flat plate securely attached to the shopping cart via the universal handlebar attachment mechanism).

In some embodiments, under normal operation, the device rests at an ergonomic angle on the handlebar (e.g., tiled upward relative to horizontal, for viewing by the user), providing an intuitive interface for scanning items and interacting with the checkout system. When a shopper needs to weigh produce, they simply tap a designated button on the screen, triggering the system to automatically adjust the screen into a flat, horizontal position aligned with the base. In some embodiments, this transformation is enabled by mechatronic components, including motorized hinges and actuators, which shift the screen while maintaining structural stability.

In some embodiments, a load cell system is integrated into the base and utilizes high-accuracy load cells calibrated to meet regulatory standards for commercial weight measurement. These load cells may be strategically positioned beneath the screen to ensure even weight distribution and precise measurement, regardless of where the product is placed. In some embodiments, complementing the load cells is pixel-sensing pressure technology, which enhances measurement accuracy by detecting micro-pressure variations across the screen's surface, providing consistent and reliable weight data.

To further support this functionality, the system may incorporate advanced mechanical and hardware design features, such as the following:

Motorized Adjustment Mechanism: Compact actuators and servo motors that allow smooth, automated transitions between the screen's angled (normal mode) and flat (scale mode) positions.

Structural Reinforcement: The base and screen are engineered with lightweight, high-strength materials such as aluminum alloys or reinforced polymers to withstand repeated use while minimizing additional weight on the shopping cart.

LED Guidance System: A LED system runs around the edges of the screen, providing visual feedback to the user, such as signaling when the device is ready for weighing, indicating the item has been weighed, and prompting the removal of the item.

Real-Time Calibration System: Integrated software ensures the load cells are continuously calibrated, accounting for environmental variables like vibrations from cart movement.

Data Processing Unit: Embedded processors analyze weight data to ensure a rapid and accurate display of the item's weight and price on the screen.

Safety and Stability Features: Anti-slip pads and secure mounts to ensure the screen remains stable during use, even when handling heavier items.

In some embodiments, once the produce or item is placed on the screen in scale mode, the system rapidly calculates the weight and corresponding price, displaying the result in real time on the screen. The LED system may then signal completion of the weighing process, prompting the shopper to remove the item and place it into the cart. In some embodiments, after the shopper indicates they are done weighing items, the screen automatically transitions back to its angled position for continued interactive use.

This integration of weight measurement technology into the smart checkout device may enhance functionality and convenience, eliminating the need for separate scales while maintaining regulatory compliance and user experience. By combining high-accuracy load cells, cutting-edge pressure-sensing technology, advanced mechanical design, and intelligent automation, this system may provide a transformative retail solution.

### Operation of the Invention

In some embodiments, operation of the interactive smart checkout device and IoT retail automation system integrates a comprehensive network of hardware and software components to provide seamless functionality across setup, shopping, and checkout processes. The following describes example operations, highlighting interactions between components and features:

### Setup and Installation Process

In some embodiments, the mobile IoT charging station, which may be designed for retrofitting into existing retail environments, is installed in designated areas such as self-checkout zones or near traditional checkout aisles. The charging station serves as the central hub for storing and charging devices and managing their connectivity. The universal attachment mechanism on each device is configured to securely attach the device to the store's existing shopping carts, accommodating varying cart designs.

In some embodiments, system integration begins with connecting the cloud platform to retail systems, including point-of-sale (POS) systems, inventory management platforms, e-commerce solutions, retail media networks (RMNs), or CPG promotional platforms. Additionally, the platform may integrate with loyalty programs, shopper profiles, and store analytics systems to enable personalized experiences. A universal POS integration system may leverage cloud communication and store WiFi (or LTE/5G connectivity) to transfer transaction data to existing checkout kiosks or POS systems, eliminating need for significant hardware modifications or complicated software integrations.

### Consumer Interaction and Item-Scanning Experience

In some embodiments, once operational, store associates prepare the system by attaching devices to shopping carts and positioning them for consumer use. Upon entering the store, shoppers locate the device enabled carts and may optionally authenticate via a unique identification process, such as entering their phone number or loyalty account information.

In some embodiments, as the shopper moves through the store, they scan items they wish to purchase using the device's barcode scanning system. This may initiate a series of processes, such as the following:
1. Item Scanning: The barcode scanning system identifies the product, the ML-powered sensor system detects cart interaction, and the AI-powered computer vision system records and analyzes the event.
2. Real-Time Feedback: The touchscreen interface and LED indicators provide immediate feedback, confirming successful scans or prompting the user for corrective action.
3. Data Communication: Scanned item data is transmitted to the cloud platform for real-time inventory tracking and shopper profile updates.

In some embodiments, the shopper also interacts with advanced digital features via the touchscreen interface, including the following:

Item-Finding Map: Navigation assistance to locate specific products within the store.

Digital Coupon Platform: Dynamic display of personalized promotions and discounts based on shopper behavior and location.

Recipe Recommendation Platform: Tailored recipe suggestions based on scanned items and shopper preferences.

AI Shopping Assistant: An NLP-powered chatbot for in-store queries and assistance.

### Shelf Monitoring and Task Management

In some embodiments, as shoppers navigate the store, the device employs smart shelf monitoring via side-mounted cameras. AI-powered computer vision models analyze shelf conditions, identifying out-of-stock items and failed planogram compliance. This data may be transmitted to the store associate dashboard, enabling real-time task notifications for restocking and corrective actions.

### Produce Weighing

In some embodiments, for pay-per-pound items, shoppers activate “scale mode,” at which point the device's high-accuracy load cell system automatically adjusts the touchscreen to a flat position. Shoppers may place produce on the screen for weighing, and the system calculates the weight and price with regulatory compliance. The interface confirms completion, and the shopper resumes normal operation.

### Checkout Operations

In some embodiments, at checkout, shoppers push their cart to the designated device area, guided by the device. A store associate may use the employee dashboard to review the shopper's cart activity, including flagged theft-prevention events. The dashboard may display short video clips of unscanned items entering the cart, allowing the associate to verify and address discrepancies.

In some embodiments, once all items are accounted for, the associate places the device into “checkout mode,” which may include the following:
1. Unlocks the device from the shopping cart handlebar for removal.
2. Instantly transfers transaction data to the store's existing POS system via encrypted cloud communication.
3. Signals the shopper to complete payment at the checkout kiosk or self-checkout terminal.

In some embodiments, after payment is processed, the shopper exits the store with their purchases, and the associate returns the device to the charging station or attaches it to another cart for the next user.

### Innovative Features and System Integration

In some embodiments, the system's operation is powered by an ecosystem of IoT hardware, AI-driven analytics, or cloud connectivity. These may include:

Universal POS Integration: operable to eliminate compatibility challenges by enabling real-time transaction data transfer to existing store systems.

Edge AI Processing: operable to reduce latency and ensures rapid data analysis, enhancing both shopper experience and operational efficiency.

Smart Shelf Monitoring: operable to empower proactive store management with real-time shelf analysis.

Dynamic Connectivity: operable to ensure uninterrupted operation via multi-channel communication (WIFI, LTE, 5G).

By integrating advanced technology with user-friendly design, the system may deliver an efficient, engaging, and secure shopping experience while optimizing retail operations and enhancing data-driven decision-making.

### Example Aspects

In some embodiments, the interactive smart checkout device and IoT retail automation system offers numerous advantages over existing smart cart solutions and self-checkout technologies by addressing critical inefficiencies and enhancing both shopper experience and retail operations. Unlike current market solutions, such as smart shopping carts, smart cart devices, and other self-checkout methods, and traditional checkout methods, the system may integrate a uniquely comprehensive suite of advanced hardware and software components, seamlessly bridging in-store shopping, data analytics, and operational optimization.

In some embodiments, the system provides a highly adaptive and modular design, which allows for seamless retrofitting into existing store environments without requiring significant infrastructural modifications. In some embodiments, the universal clamping mechanism is compatible with a wide variety of shopping carts, eliminating the need for retailers to invest in specialized or proprietary carts. Additionally, the system's unobtrusive and space-efficient mobile charging station may avoid the need for bulky charging docks or checkout kiosks, a common limitation of competing systems. By offering a streamlined solution for device storage, automatic charging, and operational management, the modular charging station may ensure consistent system uptime, simplify device deployment, and enhance overall operational efficiency for retailers.

In some embodiments, the AI-powered computer vision system incorporates data-driven convolutional neural networks (CNNs) optimized for retail-specific use cases. Combined with ML-powered sensor-fusion technology, including real-time analysis of time-of-flight (ToF) data, the system may ensure instantaneous detection of unscanned items or anomalies as they occur. This robust detection mechanism may reduce shrinkage and enhance security, and ensure that the device remains compact and cost-effective. By optimizing data pipelines and reducing the computational overhead typically required for processing large models, the system delivers cutting-edge functionality in a lightweight, accessible form factor.

These aspects may provide specific, actionable insights that are unavailable in traditional systems. For instance, the system may capture detailed shopper behavior patterns and cart-level data through seamless edge AI processing. Retailers may gain the ability to monitor in-store interactions, analyze product engagement, and optimize store layouts, enabling data-driven decisions that enhance both operational efficiency and customer experience.

In some embodiments, the multi-channel connectivity ensures reliable operation in diverse retail environments. For example, the system's ability to dynamically switch between WIFI, LTE, and 5G connections ensures uninterrupted functionality, addressing connectivity limitations that often disrupt existing systems. Integration with existing POS, inventory management, retail media networks, and CPG promotional platforms through Kwikkart's novel universal POS integration system may allow retailers to leverage their current infrastructure while enhancing operational capabilities.

In some embodiments, the system provides enhanced shopper engagement and user experience through its interactive touchscreen interface. Shoppers may benefit from personalized features such as in-store navigation, dynamic coupon delivery, recipe recommendations, and AI-powered assistance.

In some embodiments, the integrated weight system enables produce (pay-per-pound item) weighing directly on the device, eliminating the need for separate infrastructure, operational inefficiencies during the checkout process (ex, taking products out of the cart to be weighed) and provides a more streamlined shopping and checkout process compared to existing solutions. These aspects may create a more intuitive and enjoyable experience for consumers compared to existing smart carts and self-checkout lanes, which often lack the functionality to provide a streamlined 30-second checkout process (enter checkout area, pay on kiosk, and leave the store with the same shopping cart) that also prevents theft and keeps the smart checkout hardware safely and securely inside the store at all times.

In some embodiments, the real-time smart shelf monitoring system provides an additional layer of value by automatically identifying operational inefficiencies. While other systems focus solely on checkout processes, the embodied system may employ AI-powered cameras to analyze shelf conditions during cart movement, identifying out-of-stock items and planogram compliance issues. This capability, combined with IT connectivity, may enable proactive store management, ensuring inventory availability, preventing instances of failed planogram compliance, and enhancing sales opportunities.

In some embodiments, the system enhances operational efficiency for store associates. For example, by providing real-time data through the employee dashboard, associates can optimize their tasks, such as restocking, device management, and resolving flagged events. The system's intuitive theft-prevention tools, including video audit clips, may simplify and accelerate the checkout process, minimizing human error and improving customer satisfaction.

The described aspects may provide unparalleled advantages over existing solutions by, for example, combining advanced technologies, robust connectivity, seamless integration, and enhanced user experience into a single, cohesive system. It may alleviate inefficiencies and limitations of traditional self-checkout and smart cart systems and create new opportunities for data-driven decision-making, hyper-personalized digital media channels, and operational excellence in retail environments. Such embodiments may provide an improved IoT-powered retail technology that is a transformative solution in the industry.

### Alternative Embodiments

The interactive smart checkout device and IoT retail automation system may be implemented in various alternative embodiments, each tailored to address specific retail environments, customer preferences, or operational requirements while achieving the same overall objectives of enhancing user experience and streamlining retail operations. These alternative configurations may ensure adaptability and scalability across a diverse range of use cases.

In some embodiments, additional sensor types, such as RFID readers, are employed to enable automatic detection of tagged items without requiring barcode scanning. This configuration may be particularly advantageous in environments where RFID technology is already widely adopted, such as high-end retail or electronics stores. Similarly, the integration of weight sensors directly into the shopping cart basket (in addition to the touchscreen-based weight system) could provide enhanced accuracy and redundancy in monitoring unscanned items or verifying produce weights.

In some embodiments, the device's attachment mechanism could also be adapted to include permanent mounting solutions for environments that prefer dedicated carts equipped with the described devices. This approach could complement the universal clamping mechanism, offering a hybrid solution for stores that balance permanent installations with flexibility for mobile devices.

In some embodiments, in terms of connectivity, localized data processing is prioritized by implementing additional edge computing capabilities, reducing reliance on cloud connectivity in areas with limited network infrastructure. For example, a peer-to-peer networking configuration using Zigbee or Thread protocols could be employed to enable devices to communicate directly with each other and the charging station, creating a localized IoT network for real-time operations.

In some embodiments, the camera and vision systems are adapted for specialized retail environments. For example, in clothing stores, the AI-powered computer vision system may be optimized for recognizing garment tags and assisting customers with virtual fitting room features. Alternatively, for warehouse-style retailers, the system may include long-range cameras and depth sensors for analyzing larger items or pallet-based inventory.

In some embodiments, the device incorporates alternative power solutions. For example, solar-powered charging stations or carts with regenerative braking systems could reduce energy consumption, making the system more sustainable and cost-efficient for retailers prioritizing green technology.

In some embodiments, the system could be configured for non-traditional retail environments. For example, embodiments may be employed with the following features for the corresponding environments.

Pharmacy Chains: Integration of prescription scanning and verification tools into the checkout process.

DIY Stores: Customization for handling large, non-standard items with weight-based or volumetric scanning features.

Airport Retail: Lightweight, compact carts with high-security features for travelers navigating duty-free zones.

In some embodiments, the software and AI systems are adapted to include alternative algorithms tailored for specific applications. For example, computer vision models could be optimized for recognizing specialized product packaging in bulk retail settings or integrating multilingual natural language processing (NLP) for AI chatbot systems in stores with diverse customer bases.

Such embodiments demonstrate the versatility of the system, ensuring it can be adapted to meet the unique needs of various retail sectors and technological advancements while maintaining its core functionality and benefits. By enabling such flexibility, the system ensures relevance and scalability in a wide range of retail environments.

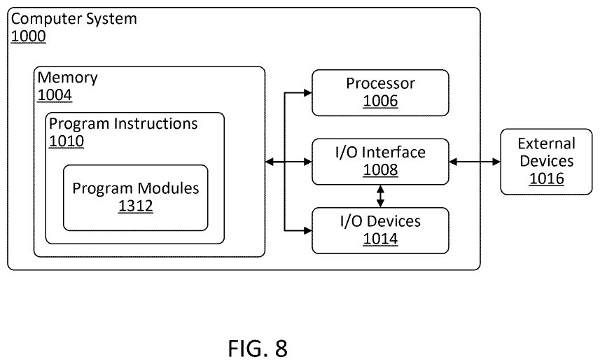

In some embodiments, the system (or a component thereof) employs a computer system that is the same or similar to that of computer system 1000 described with regard to FIG. 8. In such an embodiment, the component may execute instructions to perform one or more of the operations described here with regard to that component. For example, the smart IoT checkout device may employ a computer system similar to computer system 1000 that is operable to execute some or all of the operations of the smart IoT checkout device described here.

FIG. 8 is a diagram that illustrates an example computer system (or “system”) 1000 in accordance with one or more embodiments. The system 1000 may include a memory 1004, a processor 1006 and an input/output (I/O) interface 1008. The memory 1004 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random-access memory (SRAM), synchronous dynamic RAM (SDRAM)), or bulk storage memory (e.g., CD-ROM or DVD-ROM, hard drives). The memory 1004 may include a non-transitory computer-readable storage medium having program instructions 1010 stored on the medium. The program instructions 1010 may include program modules 1012 that are executable by a computer processor (e.g., the processor 1006) to cause the functional operations described, such as those described with regard to the entities described (e.g., the smart IoT checkout device 102 or one or more of it components, or the other entities of system 100 and environment 114), or the associated processes described.

The processor 1006 may be any suitable processor capable of executing program instructions. The processor 1006 may include one or more processors that carry out program instructions (e.g., the program instructions of the program modules 1012) to perform the arithmetical, logical, or input/output operations described. The processor 1006 may include multiple processors that can be grouped into one or more processing cores that each include a group of one or more processors that are used for executing the processing described here, such as the independent parallel processing of partitions (or “sectors”) by different processing cores to generate a simulation of a reservoir. The I/O interface 1008 may provide an interface for communication with one or more I/O devices 1014, such as a joystick, a computer mouse, a keyboard, or a display/touch screen (e.g., an electronic display for displaying a graphical user interface (GUI)). The I/O devices 1014 may include one or more of the user input devices. The I/O devices 1014 may be connected to the I/O interface 1008 by way of a wired connection (e.g., an Industrial Ethernet connection) or a wireless connection (e.g., a Wi-Fi connection). The I/O interface 1008 may provide an interface for communication with one or more external devices 1016, computer systems, servers or electronic communication networks. In some embodiments, the I/O interface 1008 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following example enumerated embodiments:

### Universal Shopping Cart Attachment Mechanism

1. An interactive checkout device comprising:
an automated universal attachment mechanism configured to enable secure integration with a wide range of pre-existing shopping cart handlebars, said mechanism comprising:
   a. adjustable clamping arms constructed from durable materials, configured to accommodate varying shopping cart designs and dimensions;
   b. spring-loaded clamps providing tension for a secure grip on the handlebars;
   c. a quick-release mechanism operable manually or electronically, enabling rapid attachment and removal of the device;
   d. rotational joints allowing multi-axis adjustment to align the device with different cart handlebar orientations;
   e. rubber padding and grips positioned on clamping surfaces to enhance friction, prevent slippage, and protect handlebars from damage;
   f. an integrated motorized system driven by servo motors and actuators to enable automated locking and unlocking of the mechanism;
   g. tension adjustment screws enabling fine-tuned clamping force for compatibility with a wide range of handlebar diameters; and
   h. a mounting plate designed for vibration resistance and weight distribution to maintain device stability during operation;
wherein said universal attachment mechanism is controlled by an onboard processing unit, capable of receiving and processing remote or localized commands to dynamically engage or disengage the attachment; and
wherein said universal attachment mechanism is configured for seamless retrofitting onto pre-existing shopping carts without requiring modification to the carts.

2. The interactive checkout device of embodiment 1, wherein the quick-release mechanism is activated wirelessly through connectivity to a cloud platform or mobile application.

3. The interactive checkout device of embodiment 1, wherein the mounting plate includes integrated sensors to detect proper alignment and secure attachment of the device to the shopping cart.

4. The interactive checkout device of embodiment 1, further comprising LED indicators integrated into the clamping arms to provide visual feedback to store associates and shoppers during the attachment or detachment process.

5. The interactive checkout device of embodiment 1, wherein the rotational joints are configured with locking screws to stabilize the device position during high-motion interactions with the shopping cart.

6. The interactive checkout device of claim 1, wherein the motorized system includes feedback sensors to monitor the clamping force and prevent over-tightening or damage to the shopping cart handlebars.

A universal attachment mechanism may provide an automated and adaptive design compatible with a wide range of shopping carts, integrating advanced mechanical components, intelligent processing, and user-centric features to streamline device deployment and removal in retail environments. By eliminating the need for proprietary shopping carts or invasive infrastructure modifications, such embodiments may provide a scalable, cost-effective, and efficient solution that surpasses the limitations of existing systems.

### Integrated Weight System

1. An interactive checkout device comprising:
a high-accuracy weight system integrated into the device, said system configured to weigh pay-per-pound items directly on the touchscreen interface of the device;
wherein the high-accuracy weight system includes:
   a. a load cell array positioned beneath the touchscreen interface, calibrated to detect and measure weight with precision suitable for regulatory compliance in commercial transactions;
   b. a pressure-sensing matrix distributed across the touchscreen surface to ensure even weight detection and accurate measurements regardless of item placement;
   c. a motorized adjustment mechanism comprising servo motors and actuators, configured to reposition the touchscreen interface from a standard angled mode to a horizontal scale mode for weighing operations; and
   d. a feedback system including LED indicators and on-screen prompts to guide users through the weighing process;
wherein the weight system is integrated with the device's central processing unit to process and display the weight and price of the item in real time; and
wherein the system dynamically adjusts calibration to account for environmental factors, such as vibrations from shopping cart movement, ensuring accurate operation during in-store use.

2. The interactive checkout device of embodiment 1, wherein the pressure-sensing matrix incorporates capacitive sensors for detecting weight distribution and ensuring stability during the weighing process.

3. The interactive checkout device of embodiment 1, wherein the motorized adjustment mechanism includes a locking system to secure the touchscreen interface in the horizontal scale mode during weighing operations.

4. The interactive checkout device of embodiment 1, further comprising a self-calibration algorithm executed by the device's central processing unit to maintain measurement accuracy over extended periods of use.

5. The interactive checkout device of embodiment 1, wherein the load cell array supports measurements up to a predefined weight threshold, ensuring compatibility with a broad range of produce and bulk items commonly sold in retail environments.

6. The interactive checkout device of embodiment 1, further comprising an encrypted communication module to securely transmit weight and pricing data to the device's cloud platform for integration with the store's point-of-sale system.

An integrated high-accuracy weight system may provide for weighing pay-per-pound items directly on the device's touchscreen interface. By combining advanced load cell technology, a pressure-sensing matrix, and a motorized adjustment mechanism, the system may provide precise, reliable measurements while maintaining a compact and user-friendly design. Real-time processing capabilities and integration with the device's edge computing and cloud platform may enhance efficiency and convenience for both shoppers and retailers.

### Theft-Prevention Computer Vision System

1. An interactive checkout device comprising:
a universally functional real-time theft-preventing computer vision system configured to identify and analyze unscanned items entering a shopping cart, said system comprising:
   a. a high-resolution, wide-angle camera array integrated into the device, positioned to monitor the area surrounding the shopping cart and detect interactions in real time;
   b. an AI-powered computer vision engine incorporating dataless deep learning models, trained to detect item-level anomalies and unscanned product entries without relying on extensive preloaded product datasets;
   c. a motion-triggered ML-powered sensor-fusion subsystem, including time-of-flight (ToF) sensors and accelerometers, for detecting and flagging cart-level interactions that may indicate unscanned items or theft-related anomalies;
   d. an onboard edge processing unit with GPU acceleration, configured to process video data in real time, segment interaction events into short clips, and analyze flagged events for potential theft;
   e. a feedback mechanism comprising visual and audio alerts triggered upon detection of anomalous interactions, to notify shoppers and store associates of unscanned items; and
   f. a secure communication interface for transmitting flagged event data, including short video clips, to a cloud platform for further analysis and storage;
wherein the system is designed to operate effectively across diverse retail environments, without requiring substantial customization or reliance on a pre-existing inventory of product-level data.

2. The interactive checkout device of embodiment 1, wherein the computer vision engine is enhanced by a neural network architecture optimized for occlusion detection, ensuring accurate identification of items partially obscured or misaligned during scanning.

3. The interactive checkout device of embodiment 1, wherein the feedback mechanism includes an adaptive LED indicator system around the device's screen to visually communicate the status of flagged interactions.

4. The interactive checkout device of embodiment 1, further comprising a dynamic calibration module that adjusts camera focus and field of view based on cart movement, ensuring consistent video capture and analysis during in-store navigation.

5. The interactive checkout device of embodiment 1, wherein the dataless deep learning models are capable of incremental learning, enabling the system to improve anomaly detection accuracy over time without requiring extensive retraining.

6. The interactive checkout device of embodiment 1, further comprising an encryption module that secures video data transmissions to the cloud platform, ensuring compliance with data privacy regulations.

A universal AI-powered theft-preventing computer vision system may provide for loss prevention in retail environments. By, for example, leveraging dataless deep learning, sensor fusion, and real-time edge processing, the system may detect unscanned items or suspicious cart interactions with accuracy and adaptability. Its ability to operate across diverse retail formats without requiring extensive product data or significant customization may provide scalability, cost-efficiency, and superior performance compared to existing theft prevention technologies.

Machine Learning-Based Sensor-Fusion System Integrated with Computer Vision

1. An interactive checkout device comprising:
a machine learning-based sensor-fusion system integrated with an AI-powered computer vision system, configured to detect shopping cart interactions and enhance the accuracy of theft-prevention mechanisms, said system comprising:
   a. a network of motion and proximity sensors, including time-of-flight (ToF) sensors, accelerometers, and gyroscopes, strategically positioned to detect movement and object placement around the shopping cart in real time;
   b. a machine learning model trained to process multi-sensor data, including motion, distance, and spatial information, to identify and classify cart interactions, such as items being placed in or removed from the cart;
   c. an AI-powered computer vision module comprising a wide-angle camera array and convolutional neural networks (CNNs), configured to analyze visual data and corroborate sensor-detected interactions with item recognition and anomaly detection;
   d. a synchronization engine configured to integrate multi-sensor data with video analysis in real time, ensuring a unified detection process that minimizes false positives and improves accuracy;
   e. an edge processing unit optimized for low-latency computation, enabling the device to process sensor and video data locally while dynamically adjusting algorithms based on environmental conditions, such as lighting or cart motion;
   f. a communication module for transmitting flagged events and analysis results to a cloud platform for storage, further processing, and integration with theft-prevention dashboards used by store associates;
wherein the system employs adaptive machine learning techniques to refine detection models over time, improving system performance without requiring manual reconfiguration;
and wherein the integration of sensor data and computer vision analysis reduces computational redundancy and enhances the overall accuracy of detecting unscanned items or suspicious cart activity.

2. The interactive checkout device of claim 3, wherein the machine learning model incorporates reinforcement learning to improve detection accuracy based on real-world interactions captured during operational use.

3. The interactive checkout device of claim 3, further comprising a calibration module that automatically adjusts ToF sensor thresholds based on environmental variables, such as aisle width or cart load.

4. The interactive checkout device of claim 3, wherein the synchronization engine includes an event prioritization algorithm that determines which interactions require immediate video analysis to optimize processing efficiency.

5. The interactive checkout device of claim 3, wherein the edge processing unit is configured with a fallback mode to store sensor and video data locally when connectivity to the cloud platform is temporarily unavailable.

6. The interactive checkout device of claim 3, further comprising a visual and audio feedback system that provides real-time notifications to shoppers and store associates when an anomaly or unscanned item is detected.

A machine learning-based sensor-fusion system integrated with computer vision may provide theft prevention and cart interaction detection. By, for example, combining real-time multi-sensor analysis with advanced computer vision capabilities, the system may identify and flag unscanned items or suspicious cart activity. Adaptive learning models and edge processing capabilities may ensure scalability and reliability across diverse retail environments, distinguishing it from existing solutions with superior efficiency, precision, and operational flexibility.

As described, provided are embodiments directed to an interactive smart checkout device and AI/ML-powered IoT retail automation system designed to enhance the in-store shopping experience, streamline checkout processes, prevent theft, monitor store environments, and enable hyper-personalized in-store digital media. Embodiments include a compact, universally adaptable device that attaches to existing shopping carts using an automated universal clamping mechanism. This may integrate an AI-powered computer vision system and an ML-based sensor-fusion subsystem to detect and prevent theft in real-time, as well as a high-accuracy weight system for weighing produce directly on the touchscreen interface. Aspects may include item scanning, real-time edge analysis for theft prevention and data analytics, multi-sensor environment monitoring, and shopper engagement tools. Such a system may be supported by a mobile charging station for device storage and charging, and a cloud platform for seamless integration with retail systems. Such a scalable, cost-effective solution may enhance retail operations by improving efficiency, enabling data-driven insights, and enhancing shopper engagement.

Provided in some embodiments, is a product scanning device that is configured to attach to a shopping cart, for use in automating a checkout process for items placed in the shopping cart. In some embodiments, the product scanning device includes the following:
a clamp configured to enable coupling of the scanning device to the shopping cart;
mapping sensors (e.g., time of flight sensors) configured to sense physical characteristics of the shopping cart, where the physical characteristics sensed are used to generate a mapping of the volume of the shopping cart (e.g., a point-cloud diagram of the shopping cart);
a wireless communication system (e.g., a WiFi system) configured to enable wireless communication of data to a cloud platform for processing;
a near filed communication (NFC) system (e.g., Bluetooth) configured to enable wireless communication of data to a user device (e.g., a user mobile phone);
a barcode scanner configured scan product bar codes and transmit corresponding product information to the cloud platform (e.g., via the wireless communication system or near filed communication with the user device);
a camera system (e.g., a wide-angled camera) configured to acquire images (e.g., video) of products being scanned or placed into the shopping cart, wherein the images are preprocessed (e.g., condensed or annotated) and uploaded to the cloud platform for processing (e.g., via the wireless communication system or near filed communication with the user device); and
a status indicator (e.g., an LED system) configured to indicate a shopping status associated with the shopping cart.

In some embodiments, the cloud platform is configured to process uploaded images (e.g., video) of products being scanned or placed into the shopping cart, to verify an identity of the product. Such verification may include, for example, comparison of the acquired image of a product to known images of the product (e.g., obtained from a retailer database, website, or the like).

In some embodiments, the cloud platform is configured to process payments for products. This may include tracking products that are placed into a shopping cart by a user, and transferring funds from an account associated with the user to the store where the products were obtained/purchased from.

In some embodiments, the user device employs a user application that is operable to communicate information to the user and to the product scanning device. This may include providing (e.g., via NFC) an identity of the user for the purpose of allocating charges for products. Further, this may include presenting, on the user device, information concerning the products that have been placed in the shopping cart.

What is claimed is:

1. An interactive checkout system comprising:
a checkout device configured to couple to a shopping cart, the checkout device comprising:
a processor;
computer vision camera system configured to identify unscanned items;
a user interface comprising a touchscreen configured to receive user input;
an attachment mechanism configured to secure the checkout device to the shopping cart; and
a weight system configured to weigh products, the weight system comprising a load cell system disposed between the touchscreen and the attachment mechanism that is configured to sense a weight of an item disposed on the touchscreen.

2. The system of claim 1, wherein a face of the touchscreen is planar and is configured to rotate between a first position and a second position.

3. The system of claim 2, wherein the face of the touchscreen is angled relative to horizontal in the first position, and the face of the touchscreen is oriented horizontally in the second position, and wherein the load cell system is configured to sense a weight of an item disposed on the face of the touchscreen oriented in the second position.

4. The system of claim 3, wherein the weight system comprises a rotation mechanism to rotate the face of the touchscreen between the first position and the second position.

5. The system of claim 4, wherein the rotation mechanism is operable to rotate the face of the touchscreen between the first position and the second position responsive to a user input provided by way of the face of the touchscreen.

6. The system of claim 4, wherein the rotation mechanism comprises a motor.

7. The system of claim 1, wherein the touchscreen is square or rectangular in shape and the load cell system comprises a load cell disposed proximate each corner of the touchscreen.

8. The system of claim 1, wherein the checkout device comprises a cart sensor system configured to detect objects entering the shopping cart.

9. The system of claim 8, wherein the cart sensor system comprises time of flight (ToF) sensors configured to detect items being placed into the cart.

10. A system comprising:
a product scanning device that is configured to attach to a shopping cart, for use in automating a checkout process for items placed in the shopping cart, the product scanning device comprising:
a clamp configured to enable coupling of the scanning device to the shopping cart;
mapping sensors configured to sense physical characteristics of the shopping cart, where the physical characteristics sensed are used to generate a mapping of a volume of the shopping cart;
a wireless communication system configured to enable wireless communication of data to a cloud platform for processing;
a near filed communication (NFC) system configured to enable wireless communication of data to a user device;
a barcode scanner configured scan product bar codes and transmit corresponding product information to the cloud platform via the wireless communication system or near filed communication with the user device;
a camera system configured to acquire images of products being scanned or placed into the shopping cart, wherein the images are preprocessed and uploaded to the cloud platform for processing via the wireless communication system or near filed communication with the user device; and
a status indicator configured to indicate a shopping status associated with the shopping cart.

11. The system of claim 10, wherein the cloud platform is configured to process uploaded images of products being scanned or placed into the shopping cart, to verify an identity of the product.

12. The system of claim 11, wherein verification comprises comparison of the acquired image of a product to known images of the product.

13. The system of claim 10, wherein the cloud platform is configured to process payments for products.

14. The system of claim 13, wherein processing payments for products comprises tracking products that are placed into a shopping cart by a user, and transferring funds from an account associated with the user to a store where the products are obtained from.

15. The system of claim 10, wherein the user device employs a user application that is operable to communicate information to the user and to the product scanning device.

16. The system of claim 15, wherein user application provides an identity of the user for allocating charges for products, and presents, via the user device, information concerning the products that have been placed in the shopping cart.
